(19) United States
(12) Patent Application Publication
(10) Pub. No.: US 2015/0100645 A1
(43) Pub. Date: Apr. 9, 2015

(54) DYNAMICALLY REBUILDING CONTENT OF SENT OUT EMAILS

(71) Applicants: JOERG STEINMANN, Voelklingen (DE); Dirk Wagner, Marplngen (DE); Martin Steiert, Heidelberg (DE)

(72) Inventors: JOERG STEINMANN, Voelklingen (DE); Dirk Wagner, Marplngen (DE); Martin Steiert, Heidelberg (DE)

(21) Appl. No.: 14/047,014

(22) Filed: Oct. 7, 2013

(51) Int. Cl. H04L 12/58

(52) U.S. Cl. CPC H04L 51/34
USPC 709/206

(57) ABSTRACT

Various embodiments of systems and methods for dynamically rebuilding content of sent out entails are described herein. The method involves receiving a request to render a content of a personalized email sent to a particular recipient of a plurality of recipients. In response to the request, an outbound email tracking table having individual tracking record for each recipient is invoked. The tracking table holds a mapping of the plurality of recipients to specific versions of an email template. The email template includes place holders for receiving variables specific to each recipient. Based on the mapping, a specific version of the email template applied in creating the email sent to the particular recipient is retrieved and the sent email is rebuilt by replacing the place holders in the retrieved email with variables specific to the particular recipient.

### FIELD

This application relates generally to providing and managing email content and more specifically to dynamically rebuilding content of emails sent out to recipients.

### BACKGROUND

Emails are sent out by communication systems for several purposes such as notification, acknowledgement, authorization, etc. When an email is sent to a specific entity, the email is usually personalized by including the name of the person, address, the type of correspondence, and correspondence details. When the email is sent to a large list of recipient email addresses, as in a marketing campaign, the email is generated using an email template. In order to personalize the email for each of the recipient email addresses, certain portions of the email template is configured as dynamic portions while the other portions of the email template remain static. The dynamic portions of the template are populated with values (e.g., values for name, address, etc.) personal to each recipient email address prior to distribution.

However, owing to the large volume of the mass distributed emails, storing a copy of all the sent emails in a communication system would require a lot of storage space in a database table in addition to lowering system performance. This problem is further magnified if the communication system operates in hosted environments such as OnDemand solutions which do not provide for storing entails in mass data processes.

### SUMMARY

Various embodiments of systems and methods for dynamically rebuilding content of, ent out emails are described herein. In an aspect, the method involves receiving a request to review/check/display a content of a personalized email sent to a particular recipient of a plurality of recipients. The plurality of recipients being members of a target group of recipients. Further, the method involves accessing an outbound email tracking table having individual tracking record for each recipient. The tracking table holds a mapping of the plurality of recipients to specific versions of an email template. The email template outlines the content of the personalized email sent to the respective one of the plurality of recipients and includes place holders for receiving variables specific to each recipient. In another aspect, based on the mapping, a specific version of the email template applied in creating the email sent to the particular recipient is retrieved from a repository. In yet another aspect, the content of the email sent to the particular recipient is rebuilt by replacing the place holders in the retrieved email with variables specific to the particular recipient. The rebuilt email content is then rendered on an output interface, e.g., a display.

These and other benefits and features of embodiments-will be apparent upon consideration of the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a conceptual diagram of an environment for executing a marketing campaign, according to one embodiment,

FIG. 2 is a flow diagram of a method for dynamically rebuilding content of sent out emails, according to one embodiment.

FIG. 3 illustrates a graphical representation of a web user interface (UT) for creating a bulk marketing campaign, according to one embodiment.

FIG. 4 illustrates a graphical representation of a web user interface (UI) showing details of an executed bulk marketing campaign, in accordance with an embodiment.

FIG. 5 illustrates a graphical representation of a web user interface (UI) showing details of marketing interactions in a campaign, in accordance with an embodiment.

FIG. 6 illustrates an exemplary rebuilt email as sent in a campaign, in accordance with an embodiment.

FIG. 7 is a block diagram of an exemplary computer system according to one embodiment.

### DETAILED DESCRIPTION

Embodiments of techniques for dynamically rebuilding content of sent out emails are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Software as a service (SaaS) sometimes referred to as “on-demand software” is a software delivery model in which software and associated data are centrally hosted on the cloud. SaaS is typically accessed by users using a thin client via a web browser. SaaS has become a common delivery model for many business applications, including accounting, collaboration, customer relationship management (CRM), management information systems (MIS), enterprise resource planning (ERP), etc. SaaS applications are hosted centrally where software and data are stored on host servers. The applications can be run on a PC with an interact connection and a web browser. One such SaaS offering is SAP Business ByDesign from SAP AG.

The SAP Business ByDesign solution offers several modules designed to track end-to-end business processes. For example, Customer relationship management (CRM) is one such module designed to support processes that span marketing, sales and service activities, Marketing includes a variety of activities such as creating and running marketing campaigns across multiple channels, connecting with target customers, generating leads, etc. One of the marketing functions supported by SAP CRM module is campaign management to control the complete marketing campaign processes including design, execution, coordination, optimization, and monitoring.

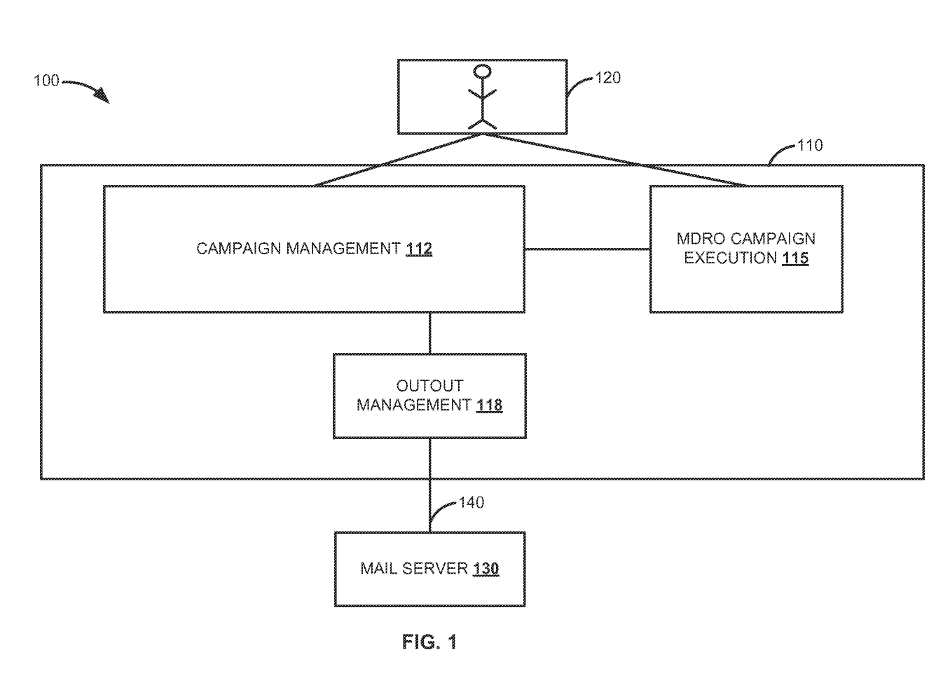

Release FP4.0 of SAP Business ByDesign solution provides for the use of email templates for generating an email. The email templates have a pre-defined text including place holders for receiving personal data pertaining to a recipient. In an aspect, the email templates are created at an external source (3^{rd} party) using state-of-the-art tools as a file and uploaded into the GRIM system. A marketing campaign would typically send several hundreds of personalized emails to recipients. However, the display/check of the sent email content is usually done only for a few of the sent personalized emails. Having been created from a common email template, the sent personalized emails are nearly identical, differing only in the place holder values. Therefore storing a copy of the entire content of each personalized email that is sent would consume a large storage space in the corresponding database table. In order to reduce the stored data to a minimum, only that information that is needed to rebuild the sent personalized email upon request is stored in the database table. The system environment for executing a marketing campaign is described with reference to a block diagram shown in FIG. 1.

FIG. 1 is a block diagram illustrating a system environment, in accordance with an embodiment. Environment 100 depicts an example configuration of a system for executing a marketing campaign in a cloud computing environment, such as environment 100. The environment 100 includes a web application server 110, client device 120, and a mail server 130, The web application server 110 includes a campaign management module 112, a Mass Data Run Object (MDRO) campaign execution module 115, and an output management module 118 communicatively coupled to a mail server 130 via network 140. The client device 120 includes a processor, an interface, a networked application or application interface, a graphical user interface (GUI), and a memory. In general, the client device 120 includes electronic computer devices operable to receive, transmit, process, and store any appropriate data associated with the environment 100 of FIG. 1. The networked application or application interface can enable the client device 120 to access and interact with applications and modules in the web application server 110 using a common or similar platform. It will be understood that there may be any number of client devices associated with, or external to, environment 100. For example, while illustrated environment 100 includes one client device 120, alternative implementations of environment 100 may include multiple client devices communicably coupled to the web application server 110.

In some instances, one or more client devices may be associated with administrators of the environment, and may be capable of accessing and interacting with the settings and operations of one or more business applications, and/or other components of the illustrated environment 100. Additionally, there may also be one or more additional client devices external to the illustrated portion of environment 100 capable of interacting with the environment 100 via network 140. Further, the terms “client” and “user” “personnel” may be used interchangeably as appropriate and refer to a person or entity. Moreover, while the client device 120 is described in terms of being used by a single user, this disclosure contemplates that many users may use one computer, or that one user may use multiple computers. For example, several employees of a client company, called users, can use the applications deployed on the corresponding client device. For instance, the term “client device” refers to a system providing a set of business applications belonging to or rented by a particular customer or business entity. Several employees of that particular customer or business entity can be users of that client device and use the business applications provided by or available on this client device.

The environment 100 is an example and, in alternative implementations, the elements illustrated in FIG. 1 may be included in or associated with different and/or additional servers, clients, networks, and locations other than those as shown. For example, one or more of the components illustrated within the web application server may be located in multiple or different servers, cloud-based or cloud computing networks, or other locations accessible to the web application server (e.g., either directly or indirectly via network 140). The client device 120 can access certain business applications built upon a similar, or common, on-demand platform. For example, the client device 120 may request certain data or data objects in a business application running in the web application server 110.

In an embodiment, the user(s) of the client device 120 creates a new marketing campaign for sending personalized emails to the members of an assigned target group. The creation of a new marketing campaign is part of a campaign definition phase in which an email template (a HyperText markup language (HTML) email form) for generating the personalized mails is created at the client device 120. In an aspect, the template is created external to the environment 100 by 3^{rd} party tools. The externally created email template is then uploaded into the campaign management module 112 and assigned to a specific campaign. Email templates are the basis on which e-mails, letters, electronic messages like SMS, and faxes are generated and sent to members of a target group. The content of the email template can be personalized by adding personal data relating to the customer into designated place holders in the template. In an aspect, the creation and maintenance of email template is streamlined to provide more Marketing-related features. For example, you can create personalized mail using HTML email and include graphics, and Uniform Resource Locators (URLs).

After the campaign definition phase is complete, the execution of the campaign is scheduled at the client device 120 by creating a new MDRO run. In an embodiment, in order to schedule the execution of the created campaign, the user activates an “Execute” option provided on a UI of the client device 120 is activated. In response to receiving the activation of the “Execute” option, the MDRO Campaign Execution module 115 calls a CREATE_EXECUTION_RUN action in a campaign node “EXECUTION_STEP.” The CREATE_EXECUTION_RUN action creates a new instance of MDRO CampaignExecutionRun. Subsequently, the UI opens a modal window on the client device 120 where the created MDRO instance can be scheduled for immediate run or execution at a future date/time. Once the campaign execution is scheduled the campaign status is set to “Active.” The campaign is then executed at the scheduled time. As used herein, a Mass Data Run Object (MDRO) executes an automatic mass processing of a business transaction, for example, the processing of a campaign execution for sending mass personalized entails.

During the execution phase, the MDRO reads all the members in the target group of recipients, and provides the member data to the campaign management module 112. Using the member data, the EXECUTE action of the EXECUTION_{—} STEP node checks whether the members in the target group are addressable or not. Further, the action creates for all the members in the target group, a corresponding instance of campaign's OUTBOUND node. For example, for each target group member assigned to the campaign, the MRDO generates campaign outbound tracking record by calling a certain action of Business Object (BO) campaign and stores the tracking record in an outbound tracking table. During campaign execution, the outbound tracking table stores outbound contact information for every member (recipient) addressed in the execution of the campaign. For all members with a valid email address, the MDRO calls a service of the campaign management module 112 in order to generate a personalized HTML email. The generated personalized email is then sent out by the Output management module 118 via the mail server 130 to all the members.

In certain instances, the sent mails may need to be displayed on a UI for viewing at a later time. However, in the current mass campaigning scenario, storing a copy of every email that is sent out would consume large main memory space and hard disk space thereby increasing the processing runtime and decreasing performance. According to one or more embodiments, instead of storing each of the sent personalized entails completely, only that information that is needed to dynamically rebuild the sent email upon request is stored in the outbound tracking table. For example, for each recipient, the place holder values that are used to generate the corresponding personalized HTML email are stored in the outbound record for the recipient. In an aspect, the campaign's OUTBOUND node stores an Extensible markup language (XML) with the place holder values in a binary stream in a new element MAILBODY_PLACE_HOLDER=VALUE. This XML is provided by the Application program interface (API) of output management module 118 where the email body is personalized.

Further, information such as, the version (e.g., correspondence language) of mail template that was used in order to generate the personalized e-mail for the corresponding recipient (the contacted account contact person), is stored in the outbound record. In an aspect, the OUTBOUND node stores the UUID of the email template in a new element MAIL_FORM_UUID. A request to view a sent email may be provided by invoking a hyperlink on the field “Sent E-Mail” on the UI.

Upon receiving the request to view the email sent to a particular recipient, the campaign management module 112 executes an API class which invokes the outbound tracking table and reads the information relating to the e-mail template used and the place holder values for the particular recipient from the record. The action then retrieves the email template or a version of the email template assigned to the campaign from the node MAIL_FORM which stores the HTML email templates. The action then rebuilds/reconstructs the sent HTML: email by replacing the place holders in the mail body of the email template by the place holder values (attributes) pertaining to the particular recipient (account contact person) retrieved from the record. In an aspect, the place holder values are stored in campaign's OUTBOUND node in element MAIL_BODY_PLACE_HOLDER_VALUE. The reconstructed sent email may then be rendered on a graphical user interface of the client device 120.

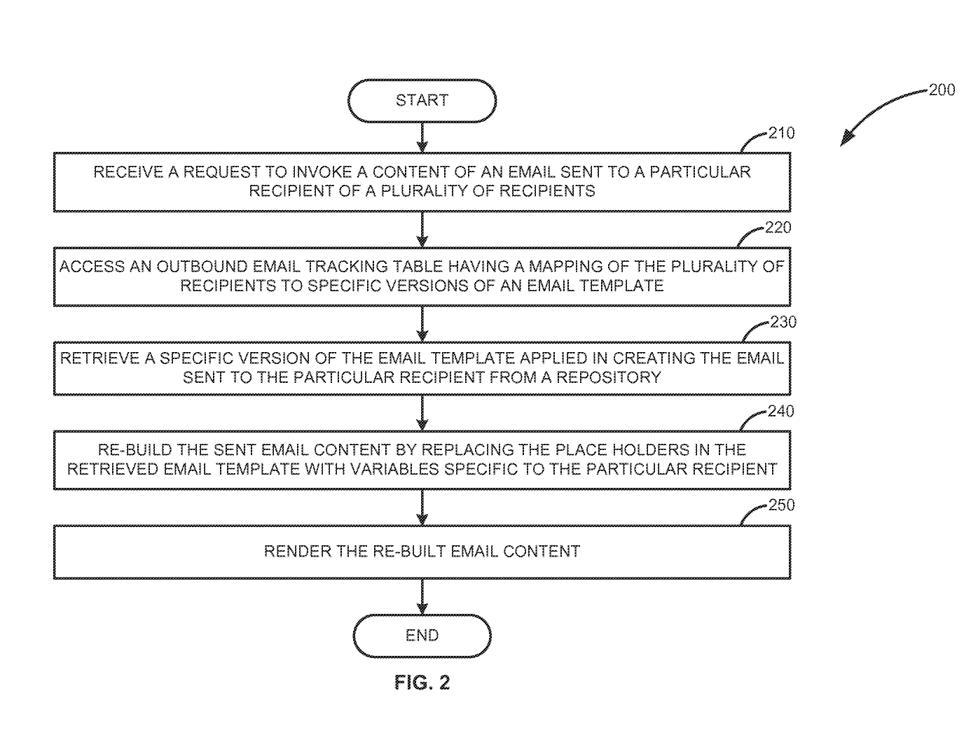

FIG. 2 illustrates a flow diagram of a method 200 for dynamically rebuilding content of sent out emails. Portions of process 200, as shown in FIG. 2, are performed at a system (e.g., system 100) having one or more processors and non-transitory memory, which stores one or more instructions to be executed by the one or more processors of the system 100. The method 200 involves receiving a request to view/check/display a content of a personalized email sent to a particular recipient of a plurality of recipients at process step 210. In an aspect, the recipients are members of a target group assigned for a specific marketing campaign. The term “recipients” as used herein refers to either an account such as an organization, a contact person for an organization, or an individual having an email address, fax or phone number. In an aspect, the recipients are classified into different target groups on the basis of certain shared marketing attributes such as age, occupation, hobbies, income, gender, etc. Within the campaign management module 112, the target groups are assigned to a marketing activity, such that, when the activity is executed, the list of customers in the target group is forwarded to the mail application for further processing. The term “personalized email” as used herein refers to an email which is customized or tailored for a particular recipient by including personal information pertaining to the recipient. Examples of personal information include, name, last name, title, designation, identification number, reference number, etc.

Upon receiving the request, an outbound email tracking table having a tracking record for each recipient is invoked, at process step 220. The email tracking table holds a mapping of the plurality of recipients to specific versions of an email template. In an aspect, the mapping holds a link to the specific email template version. In order to recover the sent email for a particular recipient, that version of the template that was used for creating the original email is invoked. In an example, the same email template may be sent out to different recipients or groups of recipients in different languages. The information relating the particular version such as language code, template ID, description, or a link to the template is mapped to the recipient's name or email address in the tracking table. The email template outlines the content of the personalized email sent to the plurality of recipients and includes place holders for receiving variables specific to each recipient.

At process step 230, based on the mapping, the specific version of the email template that was applied in creating the email sent to the particular recipient is retrieved from a repository. The sent email is dynamically reconstructed at process step 240 using the email template and the corresponding place holder values from the outbound tracking table. In an aspect, the sent entail is rebuilt by replacing the place holders in the retrieved entail with variables specific to the particular recipient. In an embodiment, the mail body of the email template contains placeholders in a certain syntax, e.g.

<span class=“variable”>

/ FormCampaignExecutionPlaceholder/Account/FormattedName

</span>

At process step 250, the rebuilt sent email is then rendered on an output interface, e.g., a graphical user interface.

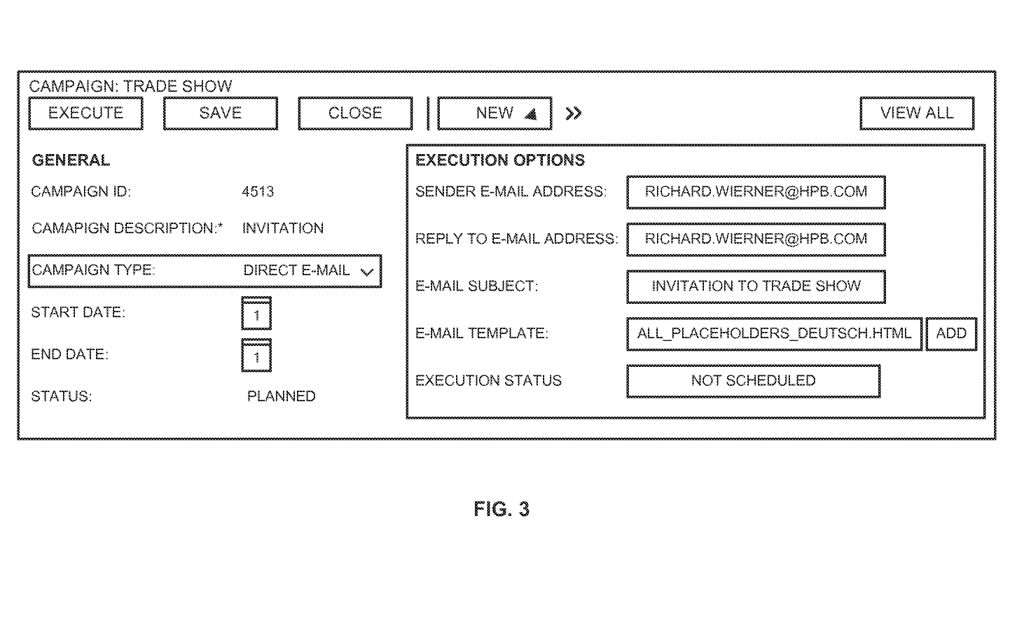

FIG. 3 illustrates a graphical representation of a web user interface (UI) for creating a bulk marketing campaign, in accordance with an embodiment, in an example campaign scenario, an invitation for an annual trade show is purported to be sent by an e-mail to a pre-defined group of recipients. In order to facilitate personalized communication with business partners on a mass scale, email templates are used in conjunction with marketing campaigns. The email template includes place holders for receiving personal information (Attributes) pertaining to a particular recipient. The email may also include a hyperlink in the mail body, using which a recipient customer may communicate his/her interest in attending the trade show. The response received for this invitation may form the basis of a second wave of campaign. For example, those that respond may receive a thank you entail whereas non-responders may receive a reminder after a week. The layout and content of an email template can be adapted according to the communication channel (email, letter, fax, and SMS) selected.

Referring to the example in FIG. 3, selecting the lab “New” to create a new campaign, renders a layout having input fields namely campaign description, campaign type, start date, end date, etc. In order to execute the campaign according to some embodiments, the campaign type is selected as “Direct e-mail.” In response to receiving the input for the campaign type field as “direct e-mail,” a modal window having execution options is displayed on the Some of the executions options are sender email address, reply-to e-mail address, e-mail subject, e-mail template, and execution status. The corresponding input fields for these options may be populated with relevant data.

The e-mail template may be uploaded from a local file by selecting the “Add” option. Selecting the “Add” option opens a file selector pop-up of the client device's operating system. During the upload an API of the output management module 118 is called which checks the HTML syntax of the email template and converts the data stream into Extensible HyperText markup language (XHTML). The content of the uploaded HTML file will be stored as XHTML in the node MAIL_FORM of BO Campaign. In an aspect, the user manually enters the subject line for the uploaded email template and sets a language code of the uploaded email template. When the email template is uploaded, the description of the email template is displayed as hyperlink. Selecting this hyperlink opens a browser window and allows for preview of the email template.

Until the execution of the campaign the selected email template can be changed by just uploading a different template. In an aspect, in case the uploaded template contains errors (e.g. virus or invalid HTML code or wrong code page or wrong placeholder names) the template is rejected and corresponding error messages are rendered on the UI. The user may then upload another template or correct the erroneous template and upload it again.

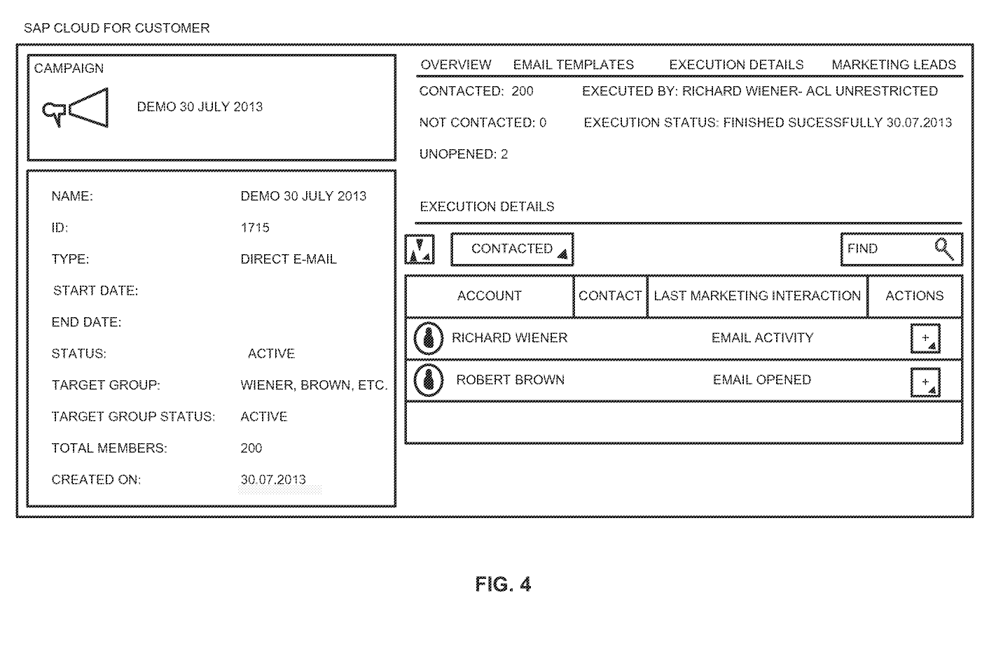

FIG. 4 illustrates a graphical representation of a web user interface (UI) showing execution details of an executed bulk marketing campaign, in accordance with an embodiment. As shown in the example in FIG. 4, the execution details interface includes information regarding the number of recipients contacted, number not contacted, number of recipients who have not opened the email, executor, and execution status. A user may view additional and more specific details by selecting an option from the drop down menu. In the given example, additional details such as recipient account name, last marketing interaction, etc., can be viewed by selecting the option “Contacted” from the drop down menu. From the Execution Details, a history of all marketing interactions carried out with a particular recipient account can be invoked by selecting a corresponding hyperlink under the “last marketing interaction” column.

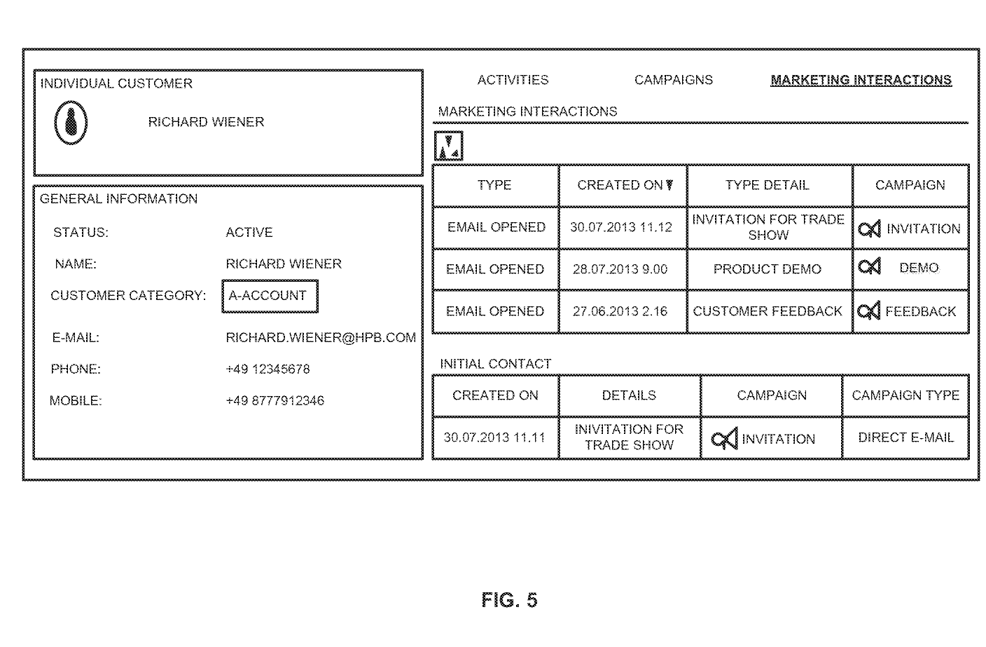

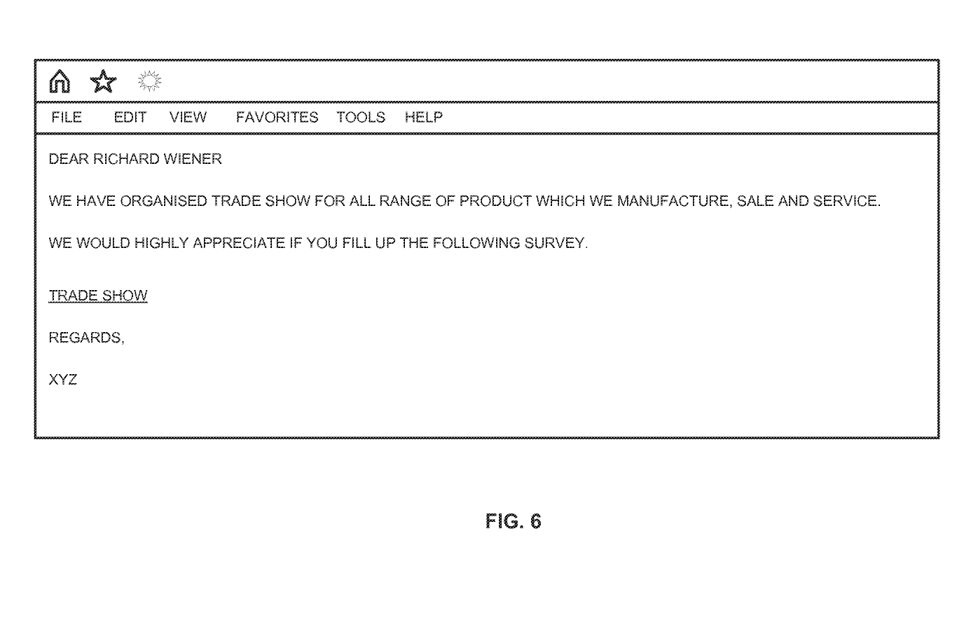

For example, selecting the hyperlink description “E-mail opened” corresponding to recipient account Joerg stoneman, opens a UI as shown in FIG. 5, showing details of the marketing interactions carried out thus far with the recipient account Joerg Stoneman. Selecting a particular interaction provides additional details in a separate panel on the UI. In the given example, selecting the interaction created on 30 Jul. 2013 renders the interaction in a “Initial contact” panel on the UT. In order to view the content of the personalized e-mail sent to account “Joerg Stoneman,” the hyperlink “Invitation for trade Show” under field “Details” is selected. In response to the selected, a browser window showing the content of the sent personalized email is rendered on the UT as shown in FIG. 6.

As shown in FIG. 6, the content of the sent personalized email is built “on-the-fly” using the email template (stored in campaign's database tables) and the name-value-pairs of the placeholder values (stored for every contacted recipient in campaign's database table). For example, the placeholders in the email template are replaced by the place holder values personal to the recipient, in case some of the place holder values pertaining to a recipient are changed (e.g. Surname is changed), the campaign still retains the original information (i.e., original surname). So, whenever a sent email is requested for viewing, the information that was relevant to the recipient at the time of creation of the originally sent e-mail is used to rebuild the sent email content in order to show the email content as it was sent.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, or other object-oriented programming language and development tools. Another embodiment may be implemented in hard-wired circuitry in place of, or in combination with machine readable software instructions.

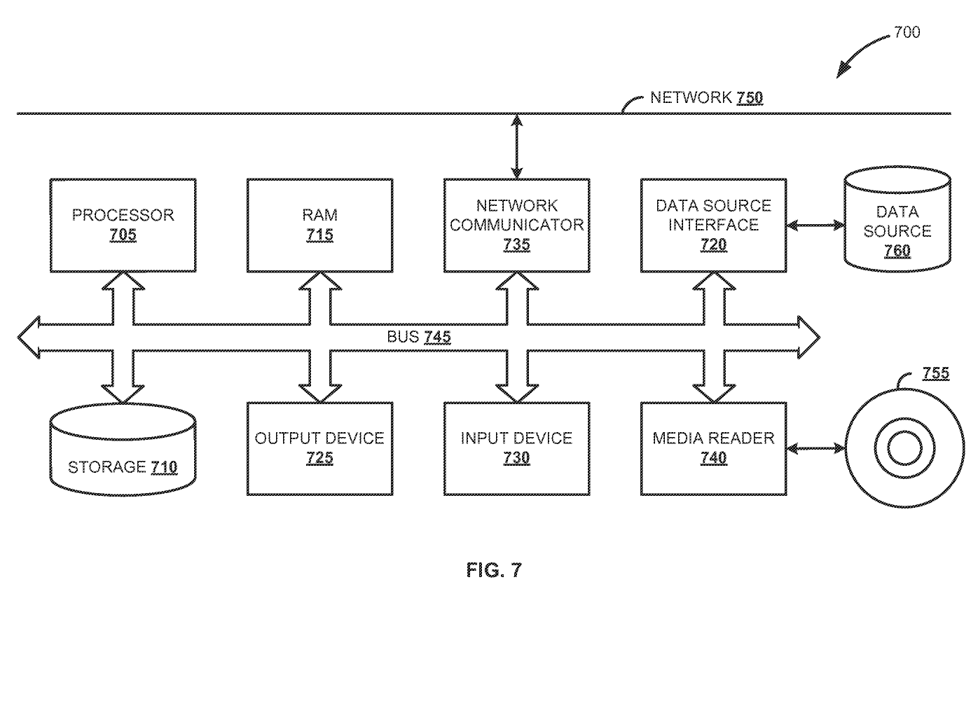

FIG. 7 is a block diagram of an exemplary computer system 700. The computer system 700 includes a processor 705 that executes software instructions or code stored on a computer readable storage medium 755 to perform the above-illustrated methods. The processor 705 can include a plurality of cores. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. According to some embodiments, such as some in-memory computing system embodiments, the RAM 715 can have sufficient storage capacity to store much of the data required for processing in the RAM 715 instead of in the storage 710. In some embodiments, all of the data required for processing may be stored in the RAM 715, The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data Sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments, One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer-implemented method for dynamically rebuilding content of sent out emails, the method comprising:
receiving a request to invoke a content of an email sent to a particular recipient of a plurality of recipients;
accessing an outbound email tracking table having a mapping of the plurality of recipients to specific versions of an email template, wherein the email template was applied in creating entails sent to the respective one of the plurality of recipients;
based on the mapping retrieving a specific version of the email template applied in creating the email sent to the particular recipient from a repository, wherein the retrieved email template comprises place holders for variables specific to the particular recipient;
re-building the sent email content by replacing the place holders in the retrieved email template with variables specific to the particular recipient; and
rendering the re-built email content.

2. The method of claim 1, wherein re-building the sent email content comprises extracting the variables specific to the particular recipient from the outbound email tracking table and replacing the place holders in the email template with the extracted variables.

3. The method of claim 1, wherein retrieving the specific version of the email template comprises identifying the particular recipient's identifier in the out bound email tracking table and determining the specific version of the email template that is associated with the identifier in the mapping.

4. A non-transitory computer readable storage medium having instructions which when executed by a computer causes the computer to:
receive a request to invoke a content of an email sent to a particular recipient of a plurality of recipients;
access an outbound email tracking table having a mapping of the plurality of recipients to specific versions of an email template, wherein the email template was applied in creating emails sent to the respective one of the plurality of recipients;
based on the mapping, retrieve a specific version of the email template applied in creating the email sent to the particular recipient from a repository, wherein the email template comprises place holders for variables specific to the particular recipient;
re-build the sent email content by replacing the place holders in the retrieved email template with variables specific to the particular recipient; and
render the re-built email content.

5. The computer readable storage medium of claim 4, wherein the email sent to the particular recipient is a personalized email in which the content of the email includes attributes specific to the particular recipient.

6. The computer readable storage medium of claim 4, wherein the plurality of recipients belong to a target group assigned to a specific campaign.

7. The computer readable storage medium of claim 4, wherein the mapping further shows an association of the plurality of recipients to respective one or more variables.

8. The computer readable storage medium of claim 7, wherein the one or more variables comprise values for the place holders in the email template.

9. The computer readable storage medium of claim 4, wherein the variables specific to the particular recipient include at least one of name, title, designation, customer ID, social security number, and reference number.

10. A system operating in a communication network, comprising:
a computer comprising a memory to store a program code, and a processor to execute the program code to:
receive a request to invoke a content of an email sent to a particular recipient of a plurality of recipients;
access an outbound email tracking table having a mapping of the plurality of recipients to specific versions of an email template, wherein the email template was applied in creating entails sent to the respective one of the plurality of recipients;
based on the mapping, retrieve a specific version of the email template applied in creating the email sent to the particular recipient from a repository, wherein the email template comprises place holders for variables specific to the particular recipient;
re-build the sent email content by replacing the place holders in the retrieved email template with variables specific to the particular recipient; and
render the re-built email content.

11. The system of claim 10, wherein the email sent to the particular recipient is a personalized email in which the content of the email includes attributes specific to the particular recipient.

12. The system of claim 10, wherein the one or more recipients belong to a target group assigned to a marketing campaign.

13. The system of claim 10, wherein the mapping further shows an association of plurality of recipients to respective one or more variables.

14. The system of claim 13, wherein the one or more variables comprise values for the place holders in the email template.

15. The system of claim 10, wherein the variables specific to the particular recipient include at least one of name, title, designation, customer ID, social security number, and reference number.

16. The system of claim 10, wherein the one or more email templates are in a HTML format.

17. The system of claim 10, wherein the email template comprises the body of the sent email message.
